(19) United States
(12) Patent Application Publication
(10) Pub. No.: US 2017/0120434 A1
(43) Pub. Date: May 4, 2017

(54) FOLDING TOOL ASSEMBLY

(71) Applicant: CHUNG-YU TSAI, Taichung (TW)

(72) Inventor: CHUNG-YU TSAI, Taichung (TW)

(21) Appl. No.: 14/924,739

(22) Filed: Oct. 28, 2015

(51) Int. Cl. B25F 1/04; B25B 15/00

(52) U.S. Cl. CPC B25F 1/04; B25B 15/008

(57) ABSTRACT

A folding tool assembly includes a base, two sidewalls connected to two sides of the base, multiple pivotable members, multiple tools and two control units. The multiple pivotable members and the multiple tools are pivotably connected to two ends of the base. Each control unit has an engaging member and resilient members, and a button is connected to the engaging member. When the pivotable member together with the tools are pivoted relative the base, the engaging member is pushed by the resilient members to be engaged with the engaging portions of each pivotable member such that the tools can be set at the desired angle.

### BACKGROUND OF THE INVENTION

1. Fields of the Invention

The present invention relates to a folding tool assembly, and more particularly, to a folding tool assembly having multiple pivotable tools which can be easily pivoted outward when in use.

2. Descriptions of Related Art

One of the conventional folding tool assembly known to applicant is disclosed in U.S. Pat. No. 8,490,523, and comprises a housing having a pair of sidewalls in spaced relation to each other. A support extends transversely between the pair of sidewalls. A plurality of work tools are pivotally supported by the support. The support defines a pivot axis for the work tools, and each work tool has an associated lock engaging member. A lock member is movable along a lock axis between a first position and a second position. When the lock member is in the first position, it is positioned to engage the lock engaging members during attempted pivoting of the work tools so that the work tools are inhibited from pivoting about the support. When the lock member is in the second position, it is positioned to disengage from the lock engaging members during attempted pivoting of the work tools so that the work tools may pivot are pivotable about the support. A gap is defined between the lock engaging member and the lock member such that the lock member does not apply an axial force along the lock axis to the lock engaging members when the lock member is in the first position and the second position.

However, the folding tool assembly uses first lock members and the push buttons to lock the lock engaging members and the work tools, so that when the user wants to pivot the lock engaging members and the work tools outward from the separator, he or she has to operate the buttons to adjust the positions of the first lock members. In this moment, the first lock members have one end thereof protruding from the first sidewall, the protrusion portion makes the user cannot hold the housing comfortably. Furthermore, the lock engaging members each have multiple indentations, so that the user can adjust the first lock member to be engaged with one of the indentions so as to adjust the angle that the work tool is set. Because the indentations are a curved recess, the groove of the first lock member may not be securely engaged with the indentation, and the work tool cannot be maintained at that desired angular position.

The present invention intends to provide a folding tool assembly to eliminate the shortcomings mentioned above.

### SUMMARY OF THE INVENTION

The present invention relates to a folding tool assembly and comprises a base, two sidewalls connected to two sides of the base, multiple pivotable members, multiple tools and two control units. The multiple pivotable members and the multiple tools are pivotably connected to two ends of the base. Each control unit has an engaging member and resilient members, and a button is connected to the engaging member. When the pivotable member together with the tools are pivoted relative the base, the engaging member is pushed by the resilient members to be engaged with the engaging portions of each pivotable member such that the tools can be set at the desired angle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the folding tool assembly of the present invention;

FIG. 2 is a perspective view to show the sidewall of the folding tool assembly of the present invention;

FIG. 2 is an exploded view of the folding tool assembly of the present invention;

FIG. 3 is a perspective view to show the pivotable member of the folding tool assembly of the present invention;

FIG. 4 is a perspective view to show the folding tool assembly of the present invention, wherein one sidewall is removed;

FIG. 5 is a perspective view to show the folding tool assembly of the present invention;

FIG. 6 is a top view of the folding tool assembly of the present invention;

FIG. 7 is a cross sectional view, taken along line A-A in FIG. 6;

FIG. 8 is another cross sectional view, taken along line A-A in FIG. 6, wherein one of the buttons is pushed;

FIG. 9 is a cross sectional view, taken along line A-A in FIG. 6, wherein one of the tools is pivoted outward, and

FIG. 10 is a perspective view of the folding tool assembly in FIG. 9.

### DETAILED DESCRIPTION OF THE PREFERRED EMBODIMENT

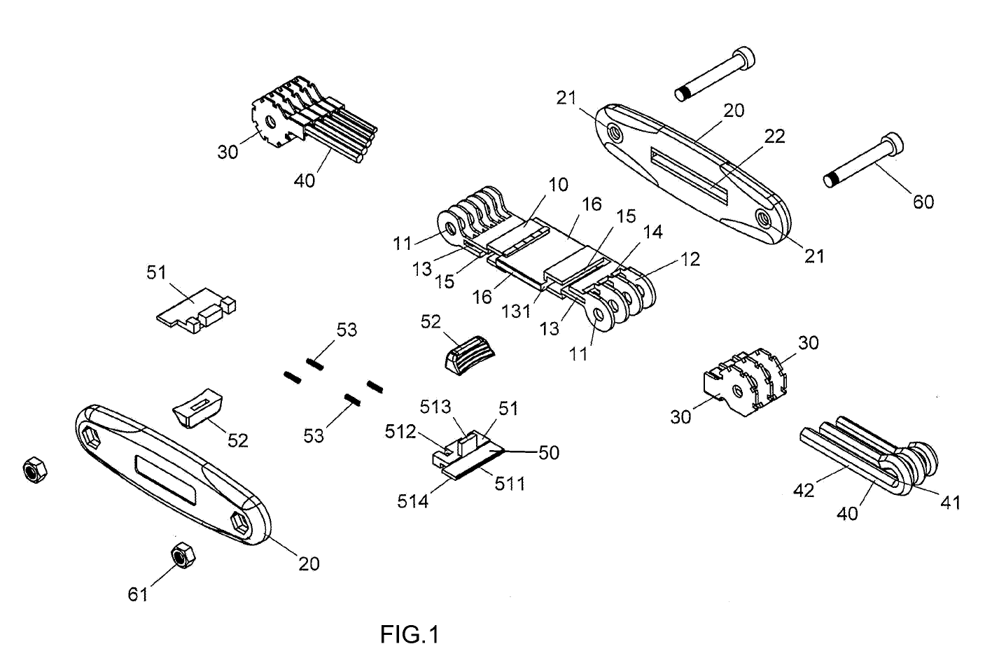

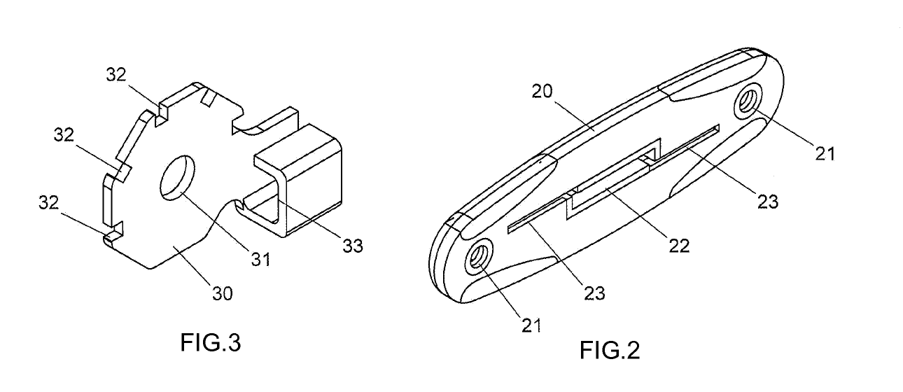

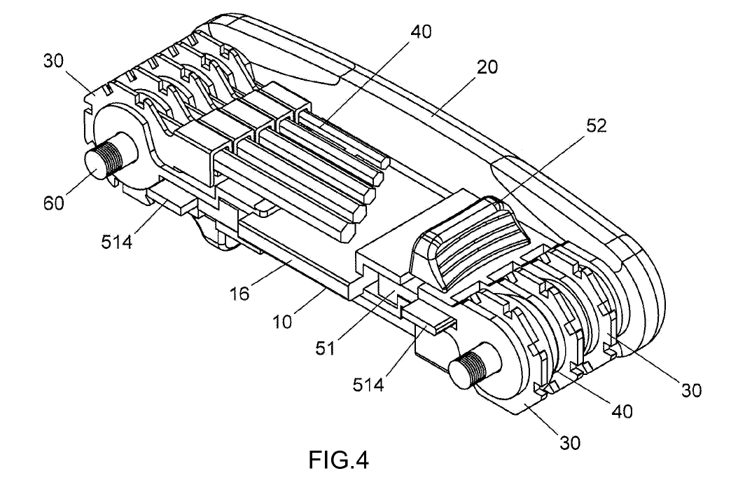

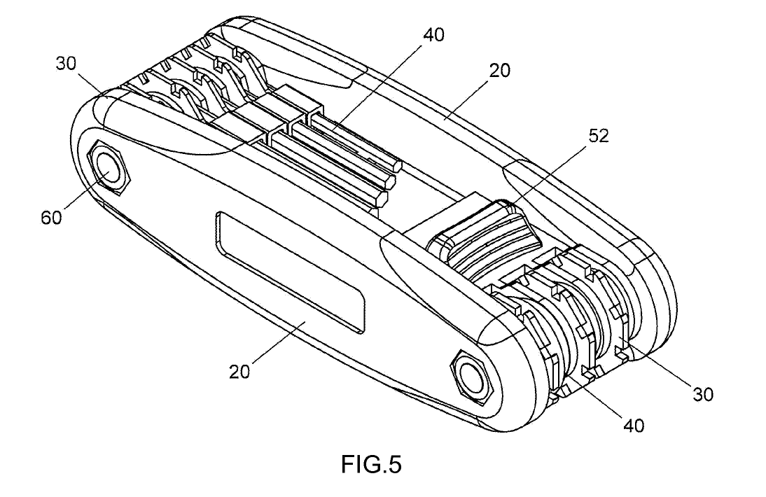

Referring to FIGS. 1 to 5, the folding tool assembly of the present invention comprises a base 10 having two first slots 13, two first protrusions 16, multiple first pivotable portions 11 and multiple rooms 12. The multiple first pivotable portions 11 are located on two ends of the base 10, and each room 12 is located between any two adjacent pivotable portions 11. The base 10 includes multiple boards which form the first slots 13 which are defined transversely through the base 10, and each first slot 13 has a contact face 131 formed therein. The base 10 has a top face and a bottom face, each of the top face and the bottom face has multiple openings 14 defined therein. The multiple openings 14 in each of the top face and the bottom face communicate with the first slot 13 and the rooms 12 corresponding thereto. Two second slots 15 are respectively defined in the top face and the bottom face of the base 10. Each of two second slots 15 communicates with the first slot 13 corresponding thereto. The two protrusion 16 are located on two sides of the base 10.

Two sidewalls 20 are respectively connected to the two sides of the base 10 and each have two second pivotal portions 21 which are respectively defined in two ends of each of the sidewalls 20. The second pivotal portions 21 are located corresponding to the first pivotal portions 11, and each of the second pivotal portions 21 a hole. An elongate hole 22 is defined in each of the two sidewalls 20 and located between the two second pivotal portions 21, so that the two protrusions 16 engaged with the two elongate holes 22 of the two sidewalls 20 to connect the two sidewalls 20 to the base 10. One of the two sidewalls 20 has two slide slots 23 defined therein which communicate with two ends of the elongate hole 22. The two slide slots 23 are located corresponding to the first slots 13.

Multiple pivotable members 30 are respectively and pivotably connected to the rooms 12 at the two ends of the base 10. Each pivotable member 30 has round disk which has a third pivotable portion 31 defied centrally therethrough, and the third pivotable portion 31 is located corresponding to the first and second pivotable portions 11, 21. Each third pivotable portion 31 is a circular hole. Each pivotable member 30 has multiple first engaging portions 32 which are located along the periphery of the round disk. One of the first engaging portions 32 of each pivotable member 30 is located corresponding to the opening 14 corresponding thereto. Each first engaging portion 32 is a recess in this embodiment. The round disk of each pivotable member 30 has a restriction portion 33 extending therefrom which has a passage.

Multiple tools 40 are respectively connected to the pivotable members 30. The tools 40 each are a wrench with a hexagonal cross section. Each room 12 has one combination of the tool 40 and the pivotable member 30 received therein. Each of the tools 40 has a fourth pivotable portion 41 and a function end 42, wherein the fourth pivotable portion 41 is located corresponding to the first, second and third pivotable portions 11, 21, 31, and the function end 42 extends through the passage of the restriction portion 33.

Two control units 50 are respectively connected to the base 10 and each control unit 50 has an engaging member 51, a button 52 and two resilient members 53. Each engaging member 51 is movably received in the first and second slots 13, 15 in each of the top face and the bottom face of the base 10. The engaging members 51 each have a second engaging portion 511 on one end thereof and two notches 512 in the other end thereof. The second engaging portion is an elongate board and engaged with one of the first engaging portions 32 of the pivotable members 30 at positions where the openings 14 are located. The two notches 512 are located opposite to the second engaging portion 511, and located corresponding to the contact face 131. Each engaging member 51 has a stop 513 extending perpendicularly therefrom which slidably extends through the second slot 15 corresponding thereto. The width of the second slot 15 is wider than the width of the stop 513 so that the stop 513 is able to move transversely in the second slot 15. Each second engaging portion 511 has a second protrusion 514 on one end thereof which is exposed beyond the base 10 and is engaged with the slide slot 23 of the sidewall 20 corresponding thereto.

The button 52 is connected to the stop 513 of the engaging member 51 and is movable transversely in the second slot 15 so as to move the second engaging portion 511 to be engaged with the first engaging portions 32 or to be disengaged from the first engaging portions 32 of the pivotable members 30. The two buttons 52 are respectively exposed beyond the top face and the bottom face of the base 10. The resilient members 53 are respectively located in the notches 512 and each are biased between the inner end of the notch 512 and the contact face 131 of the base 10. In this embodiment, the notches 512 each have a rod extending from an inner end thereof, one end of the resilient member 53 is mounted to the rod.

Two first connection members 60 each are a bolt and extend through the first pivotable portions 11 of the base 10, the second pivotable portions 21 of the sidewalls 20, the third pivotable portions 31 of the pivotable members 30, and the fourth pivotable portions 41 of the tools 40. The pivotable members 30 and the tools 40 are pivotable about the first connection member 60 corresponding thereto. Each first connection member 60 has a threaded end which is threadedly connected to a second connection member 61 which is a nut and are accommodated in the second pivotable portions 21 in the sidewall 20 corresponding thereto.

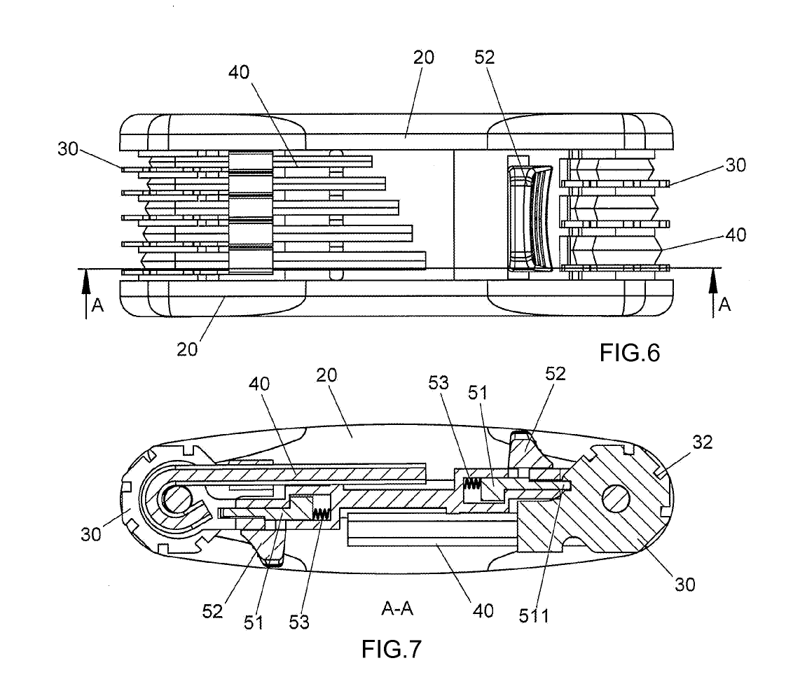

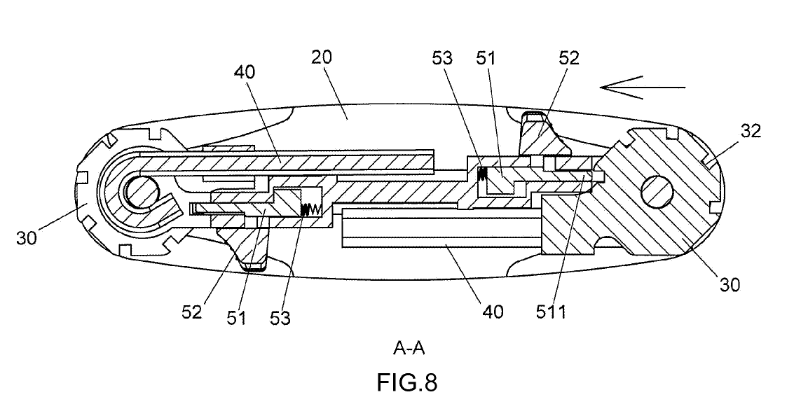

As shown in FIGS. 6 to 10, when the user pushes the button 52 toward left as shown in FIG. 8, the engaging member 51 is moved to compress the resilient member 53 so that the second engaging portion 511 is disengaged from the first engaging portions 32 of the pivotable members 30.

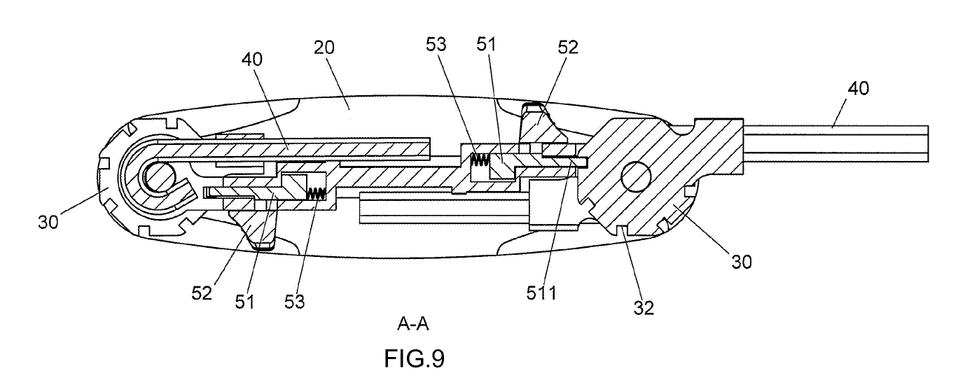

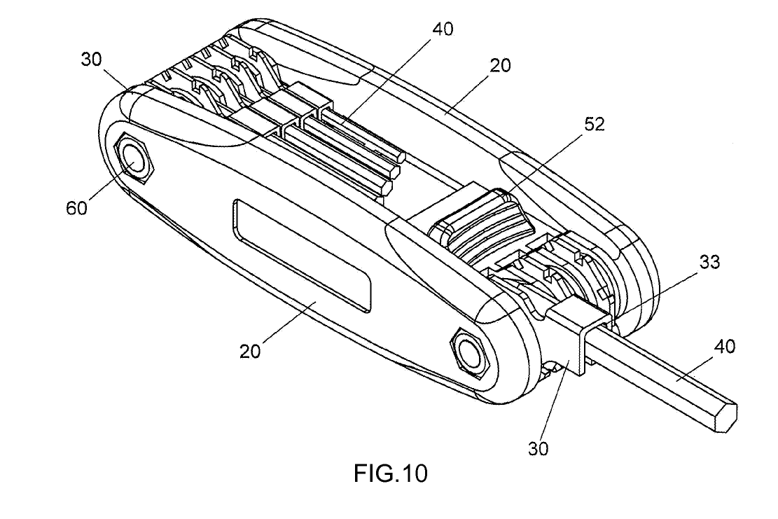

As shown in FIGS. 9 and 10, the user pivots the desired tool 40 outward to let the function section 42 be pivoted and extend out from the base 10, the button 52 is then released to allow the resilient member 53 to move the second engaging portion 511 backward to be engaged with the first engaging portions 32 of the pivotable members 30 again. Therefore, the function end 40 is secured. According to the engagement between the second engaging portion 511 and the desired first engaging portions 32 of the pivotable members 30, the angular position of the function end 42 can be set.

In another embodiment, the engaging member 51 of each control unit 50 is integral with the button 52, each of the control units 50 does not have the second protrusion 514, and the sidewall 20 does not have the slide slots 23.

The tools 40 can be received in the space between the base 10 and the sidewalls 20 so that the folding tool assembly is compact and easily carried. Each of the buttons 52 can be easily moved linearly to move the second engaging portion 511 to be engaged with or disengaged from the first engaging portions 32 of the pivotable members 30. The function end 42 of the tool 40 is conveniently pivoted to a desired angle, and the angular position is set when the button 52 is released. The board-shaped second engaging portion 511 is securely and stably engaged with first engaging portions 32 of the pivotable members 30, the tools 40 are well positioned.

While we have shown and described the embodiment in accordance with the present invention, it should be clear to those skilled in the art that further embodiments may be made without departing from the scope of the present invention.

What is claimed is:

1. A folding tool assembly comprising:
a base having two first slots, two first protrusions, multiple first pivotable portions and multiple rooms, the multiple pivotable portions located on two ends of the base, each room located between any two adjacent pivotable portions, each first slot defined transversely through the base and a contact face formed therein, the base having a top face and a bottom face, each of the top face and the bottom face having multiple openings defined therein, the multiple openings in each of the top face and the bottom face communicating with the first slot and the rooms corresponding thereto, two second slots respectively defined in the top face and the bottom face of the base, each of two second slots communicating with the first slot corresponding thereto, the two protrusion located on two sides of the base;
two sidewalls respectively connected to the two sides of the base and each having two second pivotal portions which are respectively defined in two ends of each of the sidewalls, the second pivotal portions located corresponding to the first pivotal portions, each of the second pivotal portions being a hole, an elongate hole defined in each of the two sidewalls and located between the two second pivotal portions, the two protrusions engaged with the two elongate holes of the two sidewalls, one of the two sidewalls having two slide slots defined therein which communicate with two ends of the elongate hole, the two slide slots located corresponding to the first slots;
multiple pivotable members respectively and pivotably connected to the rooms at the two ends of the base, each pivotable member having a third pivotable portion which is located corresponding to the first and second pivotable portions, each third pivotable portion being a circular hole, each pivotable member having multiple first engaging portions which are located along a periphery of a round disk, one of the first engaging portions of each pivotable member being located corresponding to the opening corresponding thereto, each first engaging portion being a recess, the round disk of each pivotable member having a restriction portion extending therefrom;
multiple tools respectively connected to the pivotable members, each room having one combination of the tool and the pivotable member received therein, each of the tools having a fourth pivotable portion and a function end, the fourth pivotable portion being located corresponding to the first, second and third pivotable portions, the function end being located in the restriction portion;
two control units respectively connected to the base and each control unit having an engaging member, a button and two resilient members;
each engaging member movably received in the first and second slots in each of the top face and the bottom face of the base, the engaging members being linearly movable in the first slots, each engaging member having a second engaging portion which is an elongate board and engaged with one of the first engaging portions of the pivotable members at positions where the openings are located, two notches defined in each of the engaging member and located opposite to the second engaging portion, the notches located corresponding to the contact face, each engaging member having a stop extending therefrom which slidably extends through the second slot corresponding thereto, each second engaging portion having a second protrusion on one end thereof which is exposed beyond the base and being engaged with the slide slot of the sidewall corresponding thereto;
the button connected to the stop of the engaging member and being movable transversely in the second slot so as to move the second engaging portion to be engaged with the first engaging portions or to be disengaged from the first engaging portions of the pivotable members, the buttons being exposed beyond the base;
the resilient members respectively located in the notches and each being biased between an inner end of the notch and the contact face of the base, and
two first connection members each extending through the first pivotable portions of the base, the second pivotable portions of the sidewalls, the third pivotable portions of the pivotable members, and the fourth pivotable portions of the tools, the pivotable members and the tools being pivotable about the first connection member corresponding thereto, each first connection member having a threaded end which is threadedly connected to a second connection member.

2. The folding tool assembly as claimed in claim 1, wherein the tools each are a wrench with a hexagonal cross section.

3. The folding tool assembly as claimed in claim 1, wherein the notches each have a rod extending from an inner end thereof, one end of the resilient member is mounted to the rod.

4. The folding tool assembly as claimed in claim 1, wherein the engaging member of each control unit is integral with the button.
